(19) United States
(12) Patent Application Publication
(10) Pub. No.: US 2003/0168909 A1
(43) Pub. Date: Sep. 11, 2003

(54) Vehicle brake hydraulic pressure generator

(75) Inventor: Akihito Kusano, Kariya (JP)

Correspondence Address: BURNS, DOANE, SWECKER & MATHIS, L.L.P., P.O. Box 1404, Alexandria, VA, 22313-1404, US

(73) Assignee: ADVICS CO., LTD.

(21) Appl. No.: 10/374,061

(22) Filed: Feb. 27, 2003

(30) Foreign Application Priority Data
Feb. 28, 2002 (JP) 2002-53261

(51) Int. Cl. B60T 8/44; B60T 11/00

(52) U.S. Cl. 303/114.1; 188/352

(57) ABSTRACT

It is proposed to improve the operating feeling of a vehicle brake hydraulic pressure generator in which the hydraulic pressure supplied from a hydraulic pressure source is adjusted to a value corresponding to the brake operating force by means of a pressure adjusting valve which changes its operating state according to displacement of an input piston or a simulator piston. A simulator chamber in the piston into which the simulator piston protrudes is connected to an atmospheric reservoir through an orifice to restrict the flow of brake fluid out of the simulator chamber while the brake is operated sharply, ther by delaying the stroke of a brake pedal.

### BACKGROUND OF THE INVENTION

This invention relates to a vehicle brake hydraulic pressure generator which adjusts the hydraulic pressure supplied from a hydraulic pressure source including a power-driven pump to a value corresponding to a brake operating force with a pressure-adjusting valve and outputs it.

A brake hydraulic pressure generator of this type is disclosed in JP patent publication 61-37140.

With the device of this publication, the brake operating force from a brake pedal is applied to an operating rod inserted in a booster piston, and transmitted to an input rod in the booster piston through a stroke limiting spring. The input rod closes an outlet valve and opens an input valve to adjust the hydraulic pressure supplied into a pressure accumulating chamber in front of the booster piston from the pump and output it. The operating rod has its tip protruding into a pressure release chamber communicating with an atmospheric replenishing container. Thus, no push-in resistance due to hydraulic pressure acts on the operating rod.

The operating rod corresponds to the simulator piston of the present application, the stroke limiting spring to an elastic member, the pressure release chamber to the simulator chamber and the replenishing container to an atmospheric pressure reservoir.

The conventional brake hydraulic pressure generator using a booster transmits brake operating force from the operating rod to the input rod through the stroke limiting spring. Therefore, if brake is operated sharply, a response delay in the brake hydraulic pressure may occur. In spite of this fact, the operating rod and the brake pedal move to positions corresponding to the brake operating force. Thus, shift occurs in the relation between the pedal stroke and the brake hydraulic pressure. This causes bad operating feeling during sharp operation of the brake.

An object of this invention is to provide a brake hydraulic pressure generator which solves this problem.

### SUMMARY OF THE INVENTION

According to this invention, there is provided a brake hydraulic pressure generator comprising a hydraulic pressure source for generating a predetermined hydraulic pressure an atmospheric reservoir a brake operating member, a simulator piston operatively coupled with the brake operating member, an elastic member for imparting a stroke corresponding to a brake operating force to the simulator piston, a simulator chamber formed in front of the simulator piston, an input piston which receives the brake operating force from the simulator piston through the elastic member, and a pressure adjusting valve which operates according to displacement of the input piston or the simulator piston to adjust the hydraulic pressure supplied from the hydraulic pressure source to a value corresponding to the brake operating force and output it, the simulator chamber being connected to the atmospheric reservoir through an orifice which limits the flow-out of brake fluid during sharp operation of the brake.

It is preferable to add a check valve which allows the flow of brake fluid from the atmospheric reservoir to the simulator chamber.

When the brake is sharply operated, flow of brake fluid out of the simulator chamber is restricted by the orifice which is provided between the simulator chamber and the atmospheric reservoir, so that pressure is generated in the simulator chamber, which delays the movement of the simulator piston. Thus, the stroke of the brake operating member is also delayed, so that a shift in the relation between the stroke and the brake hydraulic pressure decreases. Thus the operating feeling will not be uncomfortable.

When the brake is operated normally or slowly, the orifice will not restrict flow-out of brake fluid, so that the simulator piston moves without delay.

By carrying out introduction of brake fluid into the simulator chamber through the orifice when the brake is released, return of the simulator piston is delayed due to the throttle effect by the orifice. But in the arrangement in which a check valve which allows fluid flow from the atmospheric reservoir toward the simulator chamber is provided, brake fluid flows into the simulator chamber through the check valve, so that there will be no delay in the return of the simulator piston.

### BRIEF DESCRIPTION OF THE DRAWINGS

Other features and objects of the present invention will become apparent from the following description made with reference to the accompanying drawings, in which:

FIG. 1 is a view schematically showing an embodiment of the brake hydraulic pressure generator;

FIG. 2 is a view showing another embodiment;

FIG. 3A is a view showing an example of the check valve with an orifice;

FIG. 3B is a view showing how the check valve operates;

FIG. 4 is a view showing a still another embodiment; and

FIG. 5 is a view showing a further embodiment.

### DETAILED DESCRIPTION OF THE PREFERRED EMBODIMENT

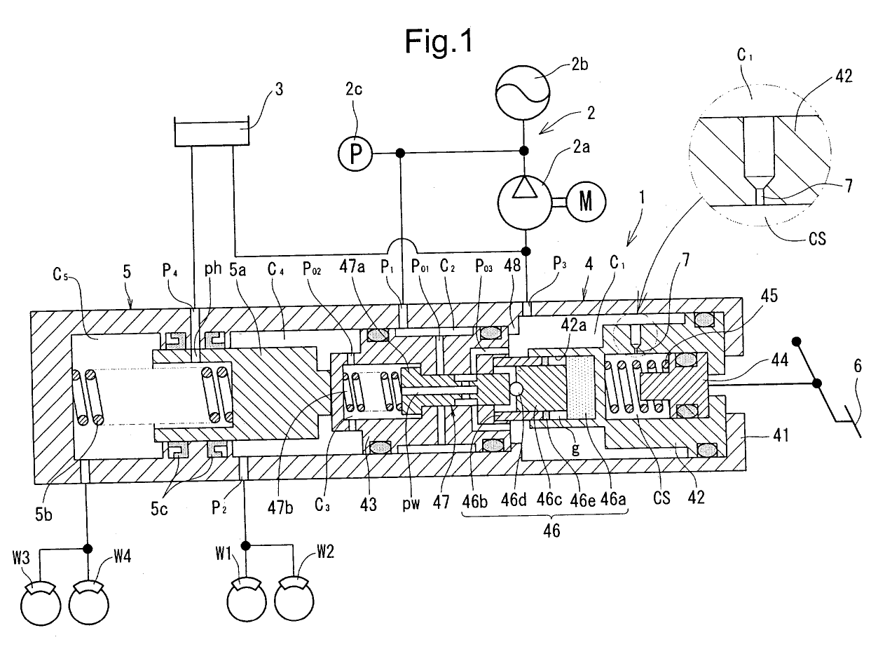

The embodiments of this invention will be described with reference to FIGS. 1-5.

The brake hydraulic pressure generator shown in FIG. 1 comprises a hydraulic pressure source 2, an atmospheric reservoir 3, a pressure adjusting device 4 and a master cylinder 5 integrally formed with the pressure adjusting device 4.

The hydraulic pressure source 2 includes a power pump 2a, a pressure accumulator 2b and a pressure sensor 2c. When the hydraulic pressure detected by the pressure sensor 2c reaches a preset lower limit, a command is given from a control device (not shown) that receives signals from the pressure sensor 2c, to activate the pump 2a. When the detected hydraulic pressure reaches a preset upper limit, the pump 2a will stop. Thus, in a normal state, hydraulic pressure within a predetermined range is always stored in the hydraulic pressure source 2, and when the brake is operated, the hydraulic pressure is supplied to the pressure adjusting device 4.

The atmospheric reservoir 3 is connected to the intake side of the pump 2a, a fluid chamber C₁ in the pressure adjusting device 4 and the master cylinder 5.

The pressure adjusting device 4 includes a housing 41, an input piston 42 mounted in the housing 41 with its tip protruding into the fluid chamber C₁, an auxiliary piston 43 arranged in front of the input piston 42, a simulator piston 44 provided in the input piston 42 with its front portion in a simulator chamber CS, an elastic member 45 (a coil spring in the figure but a rubber or an air spring may be used singly or in combination) for imparting a stroke corresponding to the brake operating force applied from a brake operating member (a brake pedal 6 in the figure) to the simulator piston 44, a distributor 46 for splitting the brake operating force transmitted from the simulator piston 44 to the input piston 42 through the elastic member 45 and transmitting it to the below-described pressure adjusting valve and an auxiliary piston 43, and a pressure adjusting valve 47 for adjusting the brake hydraulic pressure supplied from the hydraulic pressure source 2 to a value corresponding to the brake operating force. The simulator piston 44, elastic member 45 and simulator chamber CS form a stroke simulator.

The distributor 46 includes a rubber member 46a provided in an annular recess 42a formed in the tip of the input piston 42, a tubular member 46b having its one end abutting the auxiliary piston 43 and the other end inserted in the annular recess 42a, and a transmitting member 46c and a steel ball 46d mounted in the tubular member 46b and disposed between the rubber member 46a and the pressure adjusting valve 47. A gap g is provided between the rubber member 46a and a resin annular plate 46e mounted at the end of the tubular member 46b for protecting the rubber member 46a.

By providing the distributor 46, in the initial stage of brake operation, the brake operating force is transmitted only to the pressure adjusting valve 47 through the rubber member 46a, the transmitting member 46c and the steel ball 46d. When the brake operating force exceeds a certain value, the rubber member 46a, which has been resiliently deformed to get into the gap g, comes into contact with the annular plate 46e. Thereafter, part of the brake operating force is distributed through the tubular member 46b to the auxiliary piston 43 as well.

Thus, this function makes it possible to impart jumping property, which makes sharp the initial buildup of the brake hydraulic pressure adjusted by the pressure adjusting valve 47, to the brake hydraulic pressure generator. Further, if the inner diameter of the tubular member 46b and the outer diameter of the transmitting member 46c change, the distribution ratio of the brake operating forces transmitted to the pressure adjusting valve 47 and the auxiliary piston .43 changes. Further, with changes in the lengths of these members, the distribution starting time changes. Thus, by replacing the tubular member 46b and the transmitting member 46c with ones having different sizes, it is possible to change the relation between the brake operating force and the output hydraulic pressure of the pressure adjusting valve.

In this regard, the provision of the distributor 46 is preferable. But it is possible to omit it and directly transmit the force from the input piston 42 to the pressure adjusting valve 47.

Next, the pressure adjusting valve 47 shown is of a type in which pressure increase, decrease and hold are changed over by a spool 47a.

The auxiliary piston 43 has an input port P_{0.1}, output port P_{0.2} and a pressure reducing port P_{0.3}. Changeover of connection between these ports and the adjustment of the degree of opening of the valve portions are carried out by displacing the spool 47a.

The input port P_{0.1} normally communicates with the hydraulic pressure source 2 through an annular input chamber C₂ provided around the auxiliary piston 43, and an input port P₁ provided in the housing 41. The pressure reducing port P_{0.3} normally communicates with the atmospheric reservoir 3 through a fluid chamber C₁ and a drain port P₃ provided in the housing 41. The output port P_{0.2} is disposed between a fluid chamber C₃ in the auxiliary piston 43 and a fluid chamber C₄ in which the front portion of the auxiliary piston 43 is disposed, and an internal passage pw provided in the spool 47a communicates with an output port P₂ provided in the housing 41 through the output port P_{0.2}.

In the pressure adjusting valve 47 thus structured, when the spool 47a is pushed back by a return spring 47b to the illustrated original position in FIG. 1, the internal passage pw in the spool 47a is connected to the pressure reducing port P_{0.3} so as to be in the pressure-reduced state. When the spool 47a is pushed in leftwardly in FIG. 1 from this position, the internal passage pw will be separated from both the pressure reducing port P_{0.3} and the input port P_{0.1} so as to be in the output holding state. When the spool 47a is further pushed in from this position, the internal passage pw is connected to the input port P_{0.1}, so that the hydraulic pressure supplied from the hydraulic pressure source 2 flows into the fluid chamber C₄. Thus, the wheel cylinders W1 and W2 in the right-hand line in FIG. 1 (hereinafter called a first hydraulic pressure line) will be in a pressure-increased state.

The spool 47a l moves to a point where the sum of the thrust by hydraulic pressure introduced into the fluid chamber C₃ and the force of the return spring 47b, balances with the brake operating force applied through the input piston 42. Thus, adjustment is made of the degree of opening of a valve portion formed between the input port P_{0.1} and the shoulder of the spool 47a when the internal passage pw is connected to the input port P_{0.1}, and the degree of opening of a valve portion formed between the pressure reducing port P_{0.3} and the shoulder of the spool 47a when the internal passage pw is connected to the pressure reducing port P_{0.3}, so that the brake hydraulic pressure output from the output port P_{0.2} will be adjusted to a value corresponding to the brake operating force.

When hydraulic pressure is introduced into the fluid chamber C₄, the auxiliary piston 43 is pressed against a stopper 48 in the housing 41 by the hydraulic pressure. Thus, while the hydraulic pressure source 2 and the first hydraulic pressure line are normally operating, the auxiliary piston 43 is held in the illustrated position and does not move.

The master cylinder 5 comprises a master piston 5a having its front portion disposed in a master chamber C₅ and its rear portion in a fluid chamber C₄, a return spring 5b for the master piston, and two sets of cup seals 5c liquid-tightly sealing the outer periphery of the master piston 5a.

When the output hydraulic pressure is introduced into the fluid chamber C₄ through the pressure adjusting valve 47, the master piston 5a moves toward the master chamber C₅ under the pressure. In the initial stage of this movement, a hole ph formed in the master piston 5a is separated from a port P₄ communicating with the atmospheric reservoir 3. Thereafter, a fluid pressure substantially equal to the pressure in the fluid chamber C₄ is produced in the master chamber C₅, and is supplied to the wheel cylinders W3 and W4 in the second hydraulic line.

The master cylinder 5 is provided as fail-safe measures if the hydraulic pressure source 2 or the first hydraulic line should fail. That is, if hydraulic pressure should not be produced in the fluid chamber C₄ due to a failure of the hydraulic pressure source 2, the auxiliary piston 43 is moved by the brake operating force applied through the input piston 42 and the brake operating force is directly transmitted to the master piston 5a through the auxiliary piston 43. Thus, hydraulic pressure proportional to the brake operating force is outputted from the master cylinder 5 to the wheel cylinders W3 and W4 in the second hydraulic line. This avoids so-called no braking in which brakes will not work.

The brake hydraulic pressure generator 1 of FIG. 1 has in the input piston 42 an orifice 7 which limits the flow of brake fluid from the simulator chamber CS to the fluid chamber C₁ when the brake pedal 6 is sharply depressed, and allows brake fluid to flow out of the simulator chamber CS without restriction when the brake pedal 6 is stepped in normally or slowly. While one having a diameter of 1 mm or less is considered an orifice here, the diameter of the orifice 7 should be determined taking into consideration the size of the simulator piston 44, pedal stroke, etc.

In the illustrated embodiment, the orifice 7 is formed by partially reducing the diameter of a hole through which the simulator chamber CS and the fluid chamber C₁ communicate with each other. But the orifice may be one which is narrow over its entire length. The latter is easier to form because it is not necessary to reduce the hole diameter partially.

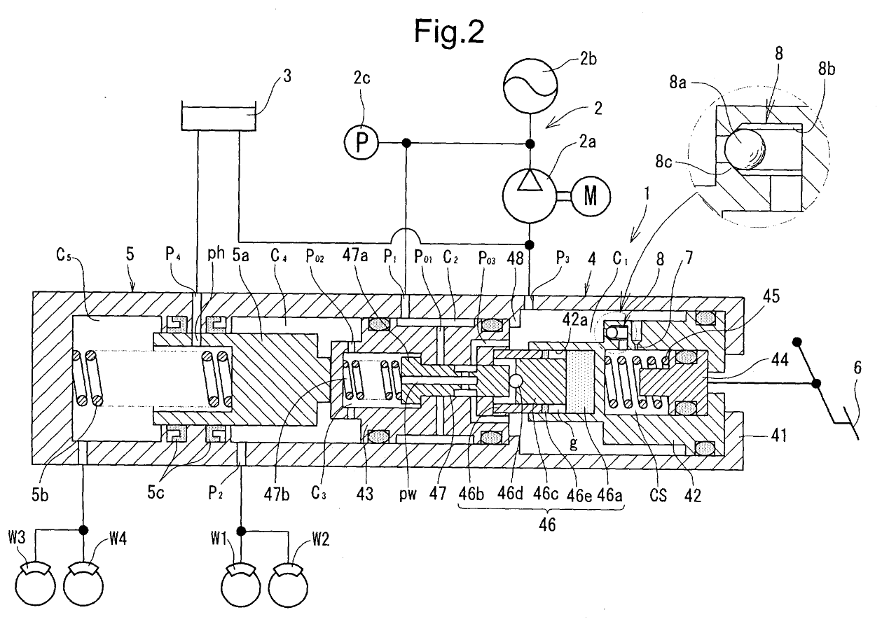

FIG. 2 is another embodiment in which a check valve 8 is added which allows a fluid flow from the atmospheric reservoir 3 to the simulator chamber CS. Since the structure is the same as in the embodiment of FIG. 1 except for the check valve 8, description is omitted.

In the brake hydraulic pressure generator 1 of FIG. 2, during brake operation, the check valve 8 is closed, so that brake fluid flows out of the simulator chamber CS through the orifice 7. Also, during release of the brakes, brake fluid smoothly flows from the fluid chamber C₁ into the simulator chamber CS through the check valve 8. Thus, the simulator piston 44 returns without delay.

The check valve 8 is shown as one having a ball as a valve body 8a. The ball is rollably retained coaxially with a valve seat 8c formed on the input piston 42. The check valve may be a poppet type one or one in which weak valve-closing force is applied to the valve body by a spring.

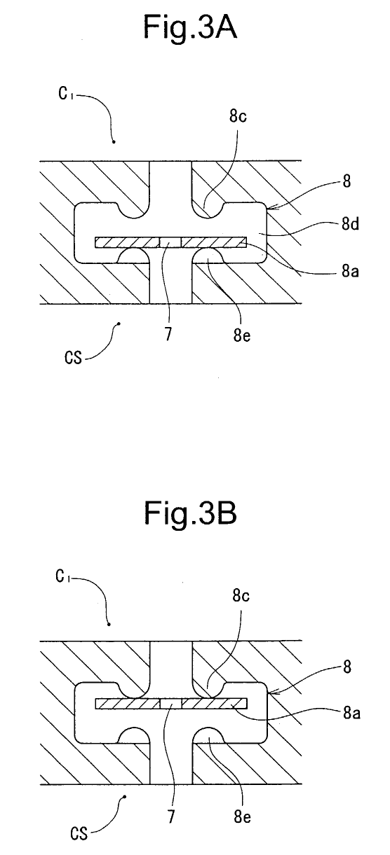

As shown in FIGS. 3A and 3B, one may be used in which the orifice 7 and the check valve 8 are integrally formed. In the arrangement shown in FIG. 3A, a thin plate-like valve body 8a is mounted in a valve chest 8d and the orifice 7 is formed in the valve body 8a. When the brake is operated sharply, the valve body 8a is pushed up by the brake fluid flowing out of the simulator chamber CS into contact with the valve seat 8c as shown in FIG. 3B, so that the check valve 8 is closed and the flow of brake fluid is restricted by the orifice 7. When the brake is released, brake fluid flows from the fluid chamber C₁ toward the simulator chamber CS through around the valve body 8a, which has separated from the valve seat 8c and is supported on angularly spaced protrusions 8e.

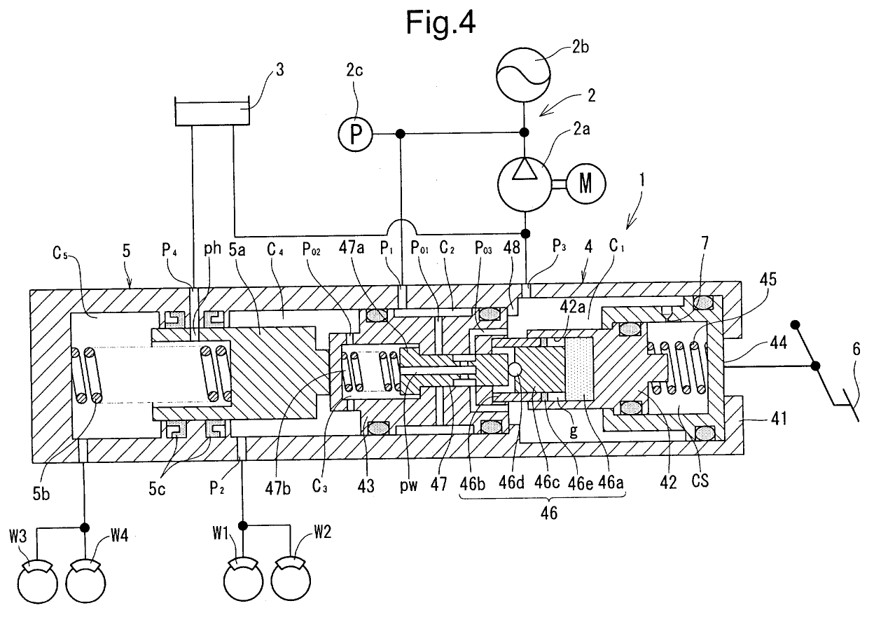

FIG. 4 shows another embodiment in which the simulator piston 44 mounted in the housing 41 is a hollow piston having its front open and the rear end closed, and the piston portion of the input piston 42 is mounted in the simulator piston 44. In this embodiment, the positional relation of the simulator piston 44 and the input piston 42 is reverse to that of the embodiment of FIG. 1. The simulator chamber CS, which is arranged in front of the simulator piston 44, is defined by the simulator piston 44. Thus, in the embodiment of FIG. 4, the orifice 7 is formed in the cylindrical portion of the simulator piston 44, and the simulator chamber CS is connected to the atmospheric reservoir 3 through the orifice 7 and the fluid chamber C₁.

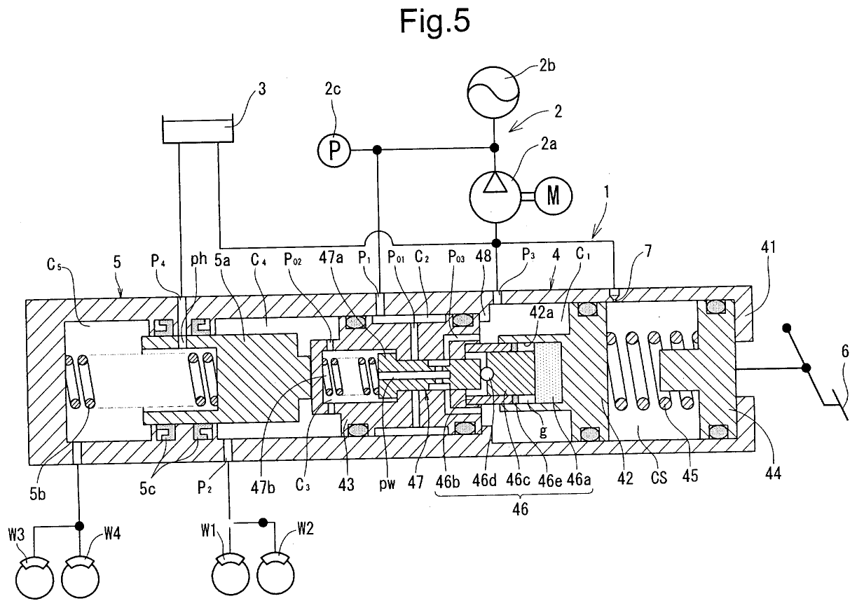

FIG. 5 shows a further embodiment in which the simulator piston 44 and the input piston 42 are arranged in series in the housing 41. The simulator chamber CS is separated by the housing 41 from outside. The orifice 7 is formed in the housing 41 and the simulator chamber CS is connected to the atmospheric reservoir 3 through the orifice 7.

Of course, in the embodiments of FIGS. 4 and 5 too, the check valve shown in FIG. 2 can be provided. Other structures of the embodiments of FIGS. 4 and 5 are the same as that of the embodiment of FIG. 1. Thus, the same numerals are used and description is omitted.

The device to which this invention is applicable is not limited to the illustrated devices. It is not the essential requirements that the pressure adjusting valve 47 is a spool valve, that the pressure adjusting valve 47 is arranged in front of the input piston so as to be acted on by brake operating force from the input piston, or that it has a master cylinder. This invention is effectively applicable to any brake hydraulic pressure generating devices in which a simulator piston is provided in a line for transmitting the brake operating force, the simulator piston protruding into a simulator chamber communicating with an atmospheric reservoir, and a pressure adjusting valve is provided to adjust the hydraulic pressure supplied from a hydraulic pressure source to a value corresponding to the brake operating force, the pressure adjusting valve changing its operating state according to displacement of the input piston and the simulator piston.

As described above, according to this invention, when the brake is operated sharply, so that a delay in response of the brake hydraulic pressure occurs, by limiting the flow of brake fluid out of the simulator chamber by means of an orifice, the stroke of the brake operating member is also delayed, so that the brake feeling is kept good.

In the arrangement in which the check valve is provided to allow fluid flow from the atmospheric reservoir to the simulator chamber, a delay in the return of the simulator piston upon release of the brake will not occur, so that good response is maintained even when the brake is relaxed or released.

What is claimed is:

1. A vehicle brake hydraulic pressure generator comprising a hydraulic pressure source for generating a predetermined hydraulic pressure, an atmospheric reservoir, a brake operating member, a simulator piston operatively coupled with said brake operating member, an elastic member for imparting a stroke corresponding to a brake operating force to said simulator piston, a simulator chamber formed in front of said simulator piston, an input piston which receives the brake operating force from said simulator piston through said elastic member, and a pressure adjusting valve which operates according to displacement of said input piston or said simulator piston to adjust the hydraulic pressure supplied from said hydraulic pressure source to a value corresponding to the brake operating force and output it, said simulator chamber being connected to said atmospheric reservoir through an orifice which limits the flow-out of brake fluid during sharp operation of the brake.

2. A vehicle brake hydraulic pressure generator as claimed in claim 1 further comprising a check valve which allows the flow of brake fluid from said atmospheric reservoir to said simulator chamber.
